(19) United States
(12) Patent Application Publication
(10) Pub. No.: US 2015/0006273 A1
(43) Pub. Date: Jan. 1, 2015

(54) PURCHASE INCENTIVIZING SYSTEM

(71) Applicants: German Scipioni, San Jose, CA (US); Michael We Chun Wu, San Jose, CA (US)

(72) Inventors: German Scipioni, San Jose, CA (US); Michael We Chun Wu, San Jose, CA (US)

(21) Appl. No.: 13/931,344

(22) Filed: Jun. 28, 2013

(51) Int. Cl. G06Q 30/02

(52) U.S. Cl. CPC G06Q 30/0224
USPC 705/14.25

(57) ABSTRACT

Systems and methods for providing purchase incentives include receiving purchase information about purchases made from a plurality of merchants by a plurality of payers. The purchase information for each purchase is associated in a database with payers that made that purchase and merchants from which that purchase was made. A first subset of the purchases that are associated with a first merchant and a first payer are determined to qualify for a first incentive provided by the first merchant, and a second subset of the plurality of purchases that are associated with a second merchant and a second payer are determined to qualify for a second incentive provided by the second merchant. The first incentive is then sent over the network to a first payer device of the first payer, and the second incentive is sent over the network to a second payer device of the second payer.

### BACKGROUND

1. Field of the Invention

The present invention generally relates to online and/or mobile payments and more particularly to a purchase incentivizing system that may be used with online or mobile payments.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Merchants may attempt to incentivize customer purchases by offering rewards for making purchases, which may include offering a discount or free product after a predetermined number of products have been purchased or a predetermined amount has been spent. Conventional merchant rewards systems include providing customers physical punch cards that the user must present when making a purchase to record that purchase. Users must then present their punch cards when enough purchases have been recorded to qualify for a reward. Such merchant rewards systems are time consuming for the merchant to manage, and can be inconvenient to participate in by users that, in many instances, may forget to present (or simply not have in their possession) their punch card for recording a purchase so that their rewards progress may be accurately tracked.

Thus, there is a need for an improved purchase incentivizing system.

### BRIEF DESCRIPTION OF THE FIGURES

FIG. 1 is a flow chart illustrating an embodiment of a method for incentivizing purchases;

FIG. 2 is a schematic view illustrating an embodiment of a purchase incentivizing system;

FIG. 3a is a schematic view illustrating an embodiment of a database in the purchase incentivizing system of FIG. 2;

FIG. 3b is a schematic view illustrating an embodiment of a database in the purchase incentivizing system of FIG. 2;

FIG. 3c is a schematic view illustrating an embodiment of a database in the purchase incentivizing system of FIG. 2

FIG. 4 is a front view illustrating an embodiment of a payer device displaying a received incentive;

FIG. 5a is a front view illustrating an embodiment of a merchant device displaying incentive details associated with a payer.

FIG. 5b is a front view illustrating an embodiment of a payer device displaying a message screen including information about payment incentives;

FIG. 6 is a front view illustrating an embodiment of a payer device displaying a payment screen including information about purchase incentives;

FIG. 7 is a schematic view illustrating an embodiment of a networked system;

FIG. 8 is a perspective view illustrating an embodiment of a payer device;

FIG. 9 is a schematic view illustrating an embodiment of a computer system; and

FIG. 10 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Embodiments of the present disclosure provide a system and method for incentivizing purchases. A third party system provider such as, for example, a payment service provider (e.g., PayPal, Inc. of San Jose, Calif.), may operate to provide payment services to facilitate payments between any of a plurality of a payers and any of a plurality of merchants, and in the course of providing those payment services, may also operate to provide purchase inventive programs for any of the plurality of merchants. For example, during the provision of payment services, the payment service provider compiles purchase information for a plurality of purchases from any or all of the plurality of merchants by any or all of the plurality of payers. In the operation of the purchase incentive programs for any of the plurality of merchants, the payment service provider may determine subsets of the plurality of purchases associated with merchants and payers that qualify for an incentive. Incentives may be provided by the merchants and/or determined by the payment service provider without any input from merchants, and are offered as a reward to payers for making purchases (e.g., based on a number of purchases made, an amount of purchases made, etc.) In response to determining that subsets of the plurality of purchases associated with merchants and payers qualify for incentives, the payment service provider sends those incentives to the qualifying payers.

Furthermore, purchase incentivizing system providers may determine when payers are close to qualifying for incentives provided by merchants. In response, the purchase incentivizing system providers may notify the merchants about payers that are close to qualifying for incentives and/or notify the payers that are close to qualifying for incentives directly. Further still, the purchase incentivizing system provider may monitor the purchases made by payers from merchants to determine how often purchases are being made. In the event that a significant drop in purchases is detected, the purchase incentivizing system provider may notify merchants about their reduced purchase payers and give those merchants an opportunity to have incentives sent to those reduced purchase payers.

The embodiments of the systems and methods discussed herein that provide third party management of purchase incentivizing programs for multiple merchants provide several benefits over the conventional purchase incentivizing systems discussed above, including taking the responsibility off of merchants to manage those purchase incentivizing programs, using the granularity of purchase knowledge available to a payment service provider to focus the purchase incentive program in a manner unavailable to most merchants, providing the ability to accurately track payer progress towards incentives, providing the ability to target payers based on purchase histories and/or outside of a current transaction, and/or a variety of other benefits that will be apparent to one skill in the art that is in possession of the teachings of the present disclosure.

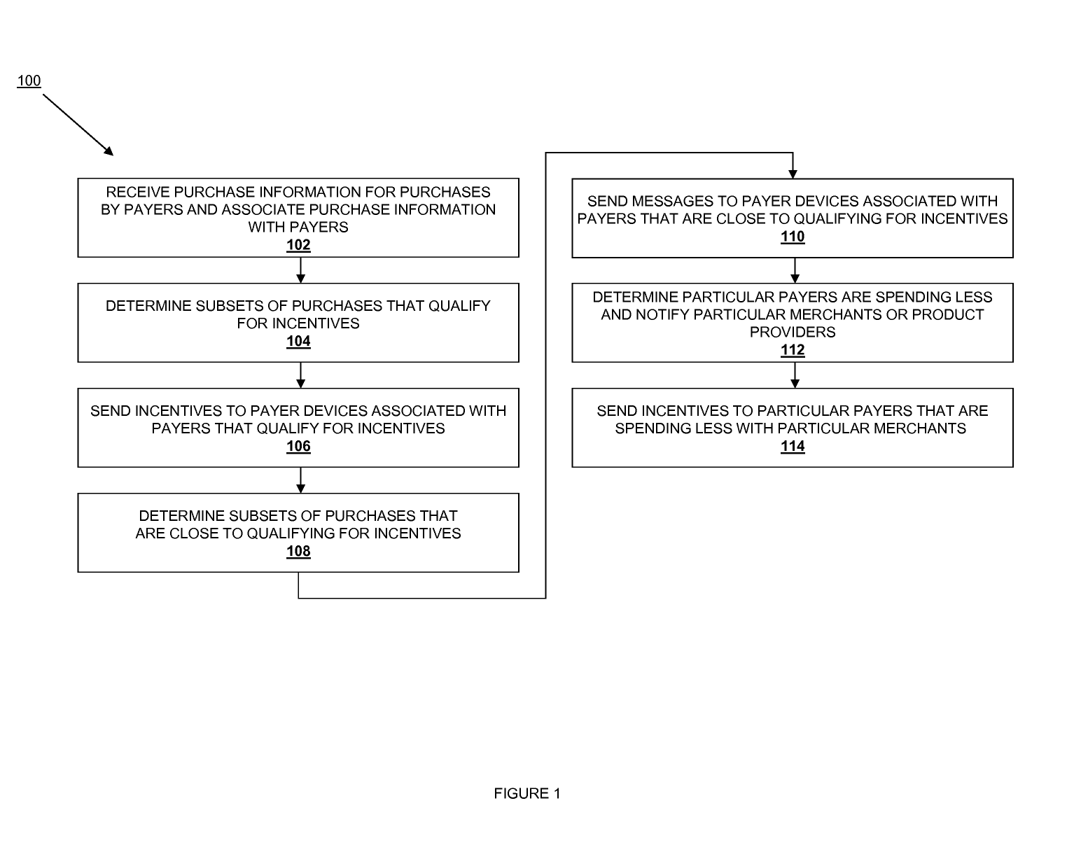

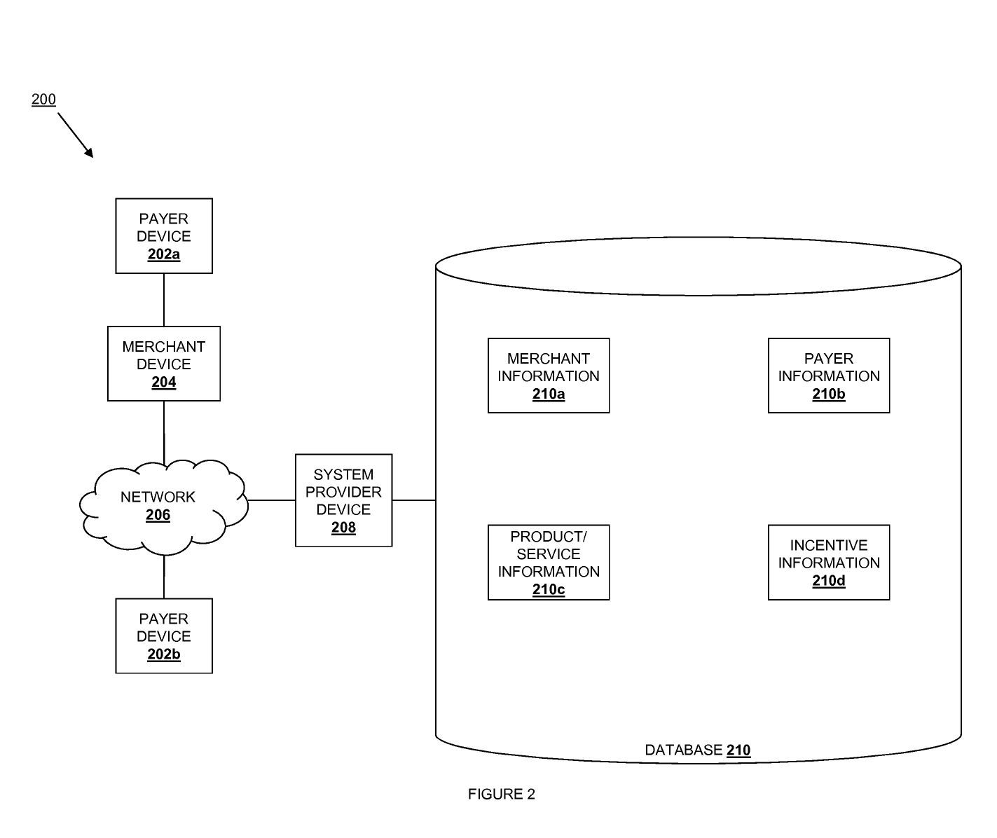

Referring now to FIGS. 1 and 2, an embodiment of a method 100 for incentivizing purchases is illustrated. The method 100 begins at block 102 where purchase information is received for purchases by payers, and that purchase information is associated with the payers. In many of the embodiments discussed below, the purchase incentivizing system provider is a payment service provider such as, for example, PayPal, Inc., of San Jose, Calif., that provides payment services for merchants and payers. For example, the payment service provider may provide merchant accounts to merchants that are linked with financial accounts of the merchants, and payer accounts to payers that are linked with financial accounts of the payers. Purchases may then be made from a merchant by a payer when the payment service provider transfers funds from the financial account of the payer to the financial account of the merchant. However, the purchase incentivizing system may be provided by a variety of other entities including, but not limited to, financial account providers (e.g., the providers of the financial accounts to the merchant and/or user), third party purchase aggregation providers (e.g., an entity that tracks selling and/or spending behavior for merchants and/or payers), and/or a variety of other entities known in the art.

FIG. 2 illustrates an embodiment of a payment incentivizing system 200 that includes payer devices 202a and 202b communicatively coupled with a merchant device 204, either directly (as illustrated between the payer device 202a and the merchant device 204) or through a network 206 (as illustrated between the payer device 202b and the merchant 204.) The merchant device 204 is communicatively coupled through the network 206 to a system provider device 208 that is coupled to a database 210. Each of the payer devices 202a and 202b are associated with payers, and the merchant device 204 is associated with a merchant. As discussed above, each of the payers associate with the payer devices 202a and 202b may be provided payer accounts (e.g., from a payment service provider) and/or financial accounts (e.g., from a financial account provider), and the merchant associated with the merchant device 204 may be provided a merchant account (e.g., from a payment service provider) and/or a financial account (e.g., from a financial account provider). While only two payer devices and one merchant device are illustrated in the payment incentivizing system 200 for clarity of illustration and discussion, the payment incentivizing system 200 of the present disclosure may include any number of merchants and any number of payers.

In an embodiment of block 102, the system provider device 206 receives purchase information about purchases from merchants by payers, and that purchase information is associated with the merchants, merchant locations, products services, and/or payers in the database 208. As is known in the art, a payer may select products and/or services offered by a merchant and conduct a purchase process in order to transfer funds to the merchant in exchange for the purchase. In an embodiment, a payer may use the payer device 202a to directly communicate with the merchant device 204, as illustrated, to purchase products and/or services from the merchant. For example, the payer device 202a may include a computing device configured to electronically purchase information to the merchant device 204 (e.g., via a purchasing application on a mobile device), a payment card including purchase information (e.g., encoded on a medium such as a magnetic strip, a radio frequency identification (RFID) chip, etc.) that is readable by the merchant device 204, and/or a variety of other payment devices known in the art. At block 102, the payer may use the payer device 202a to either provide purchase information to the system provider device 208 over the network 206 (e.g., when a purchase application on the payer device 202a communicates over the network 206 directly with the system provider device 208 even when direct communication is available between the payer device 202a and the merchant device 204), or provide the purchase information to the merchant device 204 for transfer over the network 206 to the system provider device 208.

In another embodiment, a payer may use the payer device 202b to communicate with the merchant device 204 over the network 202b, as illustrated, to purchase products and/or services from the merchant. For example, the payer device 202b may include a computing device configured to connect to an Internet website provided by the merchant device 204 (or other third party website provider), browse through products and/or services, select products and/or services for purchase, and provide purchase information. At block 102 the payer may use the payer device 202b to either provide purchase information to the system provider device 208 over the network 206, or provide the purchase information to the merchant device 204 for transfer over the network 206 to the system provider device 208.

The database 210 includes a variety of information for operating the purchase incentivizing system 200. In the illustrated embodiment of FIG. 2, the database 210 includes merchant information 210a, payer information 210b, product/service information 210c, and incentive information 210d. While each of the merchant information 210a, payer information 210b, product/service information 210c, and incentive information 210d are illustrated as separate, any of that information may be combined, shared, and/or linked together throughout the database 210 without departing from the scope of the present disclosure. Furthermore, while the database 210 is illustrated as a single database directly coupled to the system provider device 208, the database 210 may be provided by any number of databases and/or storage devices, and may be connected to the system provider device 208 directly and/or over any number of networks.

In an embodiment, the merchant information 210a may include, for each of a plurality of merchants, information about one or more merchant accounts associated with that merchant (e.g., provided by a payment service provider), information about one or more financial accounts associated with that merchant (e.g., provided by a financial account provider), information about one or more incentive programs associated with that merchant, information about one or more payers associated with that merchant, information about one or more products and/or services associated with that merchant, information about one or more merchant locations associated with that merchant, contact information associated with that merchant, and/or a variety of other merchant information known in the art.

In an embodiment, the payer information 210b may include, for each of a plurality of payers, information about one or more payer accounts associated with that payer (e.g., provided by a payment service provider), information about one or more financial accounts associated with that payer (e.g., provided by a financial account provider), information about one or more incentive programs associated with that payer, information about one or more merchants associated with that payer, information about one or more products and/or services associated with that payer, contact information associated with that payer, and/or a variety of other payer information known in the art.

In an embodiment, the product/service information 210c may include, for each of a plurality of products and/or services, information about one or more incentive programs associated with that product and/or service, information about one or more payers associated with that product and/or service, information about one or more merchants associated with that product and/or service, information about one or more product and/or service providers associated with that product and/or service, and/or a variety of other product/service information known in the art.

In an embodiment, the incentive information 210d may include, for each of a plurality of incentive programs, information about one or more merchants associated with that incentive program, information about one or more merchant locations associated with that incentive program, information about one or more payers associated with that incentive program, information about one or more products and/or services associated with that incentive program, information about incentives associated with that incentive program, information about a number of purchases needed to qualify for incentives associated with that incentive program, information about an amount of purchases needed to qualify for incentives associated with that incentive program, and/or a variety of other incentive information known in the art.

In an embodiment, the incentive information 210d may be provided in the purchase incentivizing system 200 in a variety of ways. For example, merchants may provide incentive information detailing one or more of their incentive programs to the system provider device 208 (e.g., from the merchant device 204 to the system provider device over the network 206.) In another example, a merchant location that includes a plurality of merchants (e.g., a mall, a city, a shopping district, etc.) may provide incentive information detailing one or more of their incentive programs to the system provider device 208. In another example, a product provider (e.g., a product manufacturer, a product reseller, a product distributor, etc.) may provide incentive information detailing one or more of their incentive programs to the system provider device 208. In another example, a financial account provider (e.g., a credit account provider, a checking account provider, a savings account provider, etc.) may provide incentive information detailing one or more of their incentive programs to the system provider device 208. In another example, a payment service provider may provide incentive information detailing one or more of their incentive programs to the system provider device 208. Thus, in some embodiments, the purchase incentivizing system provider may determine the incentive information that details the incentive program used to incentivize purchases by the payers.

At block 102, the purchase information for each of a plurality of purchases from merchants by payers that is received by the system provider device 208 may be associated in the database 210 with the payers that made that purchase, the merchants from which that purchase was made, the merchant location from which that purchase was made, and/or the product or service that was purchased. In an embodiment, the merchant information 210a associated with a particular merchant from which a purchase was made may have the corresponding purchase information for that purchase associated with it. For example, information about the payer making the purchase may be associated with the merchant information for the merchant from which the purchase was made, information about the merchant location from which the purchase was made may be associated with the merchant information for the merchant from which the purchase was made, information about the product and/or service purchased may be associated with the merchant information for the merchant from which the purchase was made, information about the amount of the purchase may be associated with the merchant information for the merchant from which the purchase was made, and/or a variety of other purchase information known in the art may be associated with the merchant information from which the purchase was made.

In an embodiment, the payer information 210b associated with a particular payer making a purchase may have the corresponding purchase information for that purchase associated with it. For example, information about the merchant from which the purchase was made may be associated with the payer information for the payer making the purchase, information about the merchant location from which the purchase was made may be associated with the payer information for the payer making the purchase, information about the product and/or service purchased may be associated with the payer information for the payer making the purchase, information about the amount of the purchase may be associated with the payer information for the payer making the purchase, and/or a variety of other purchase information known in the art may be associated with the payer information for the payer making the purchase.

In an embodiment, the product/service information 210c associated with a particular product and/or service purchased may have the corresponding purchase information for that purchase associated with it. For example, information about the merchant from which the purchase was made may be associated with the product/service information for the product and/or service that was purchased, information about the merchant location from which the purchase was made may be associated with the product/service information for the product and/or service that was purchased, information about the payer making the purchase may be associated with the product/service information for the product and/or service that was purchased, information about the amount of the purchase may be associated with the product/service information for the product and/or service that was purchased, and/or a variety of other purchase information known in the art may be associated with the product/service information for the product and/or service that was purchased.

Thus, at block 102 of the method 100, the system provider device 208 receives purchase information for a plurality of purchases and may associate that purchase information with merchants, merchant locations, payers, products, services, and/or any other criteria associated with purchase incentivizing systems and used to track and reward payer purchases by providing incentives in exchange for those purchases. One of skill in the art will appreciate from the teachings of the present disclosure that transactions between any number of payers and merchants may be compiled by the system provider device 208. For example, in embodiments when the system provider device 208 is payment service provider or financial account provider, the compiling of purchase information for the plurality of purchases may be performed as part of the payment service or financial account provisioning of the transaction involving the purchase. Furthermore, as discussed below, while the merchants may be involved with incentive program details (e.g., the merchants may provide the incentive information 210d for their respective incentive programs), such involvement is not necessary, and a purchase incentivizing system provider may compile purchase information for a plurality of purchases from a merchant for an incentive program that that merchant is not involved in (but which may incentivize payers to make purchases from the merchant.) For example, a financial account provider may incentivize purchases using a financial account by offering incentives for making purchases from a particular merchant that a payer frequents (e.g., by offering merchant specific credits for purchases made from that merchant using the financial account.)

Referring now to FIGS. 1, 2, 3a, 3b, and 3c, the method 100 then proceeds to block 104 where a subset of purchases are determined to qualify for incentives. In an embodiment, the system provider device 208 may use any or all of the merchant information 210a, the payer information 210b, the product/service information 210c, and the incentive information 210d to determine whether a subset of purchases by a payer qualifies for an incentive.

In an embodiment, for each merchant associated with the merchant information 210a, the system provider device 208 may periodically (e.g., at predetermined times or in response to an instruction) review the merchant information for that merchant to determine whether a subset of the purchases corresponding to the purchase information associated with that merchant information qualifies for an incentive. For example, for a particular merchant, the system provider device 208 may retrieve the incentive information 210d associated with that particular merchant, and then review the purchase information associated with that particular merchant in the merchant information 210a to determine whether purchases from that merchant by any payer qualify for an incentive included in the incentive information 210d.

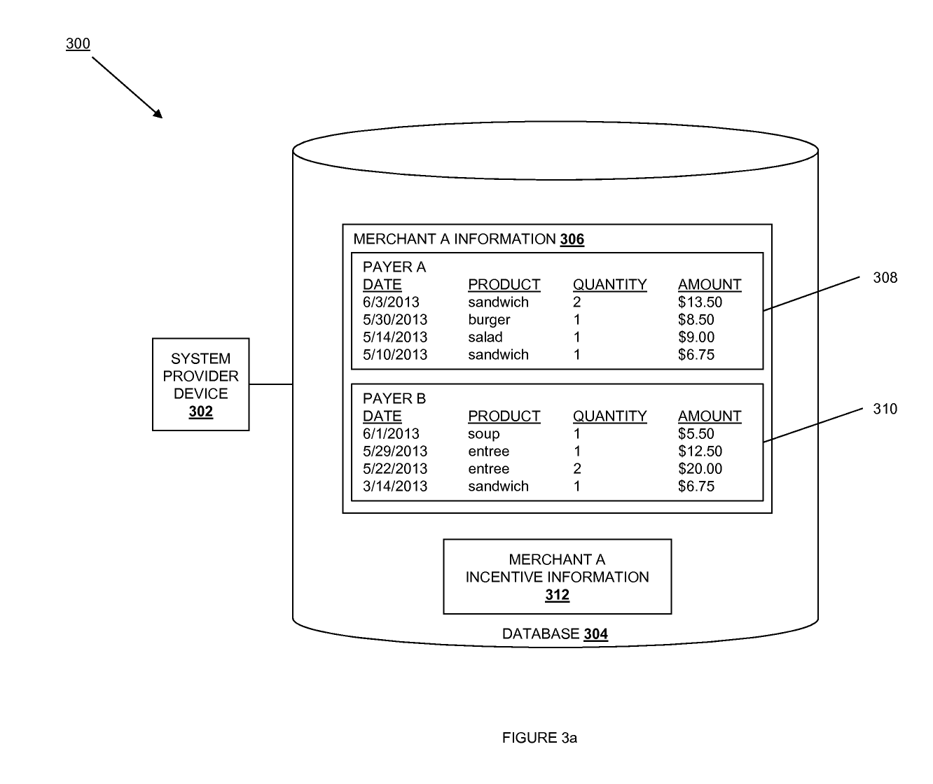

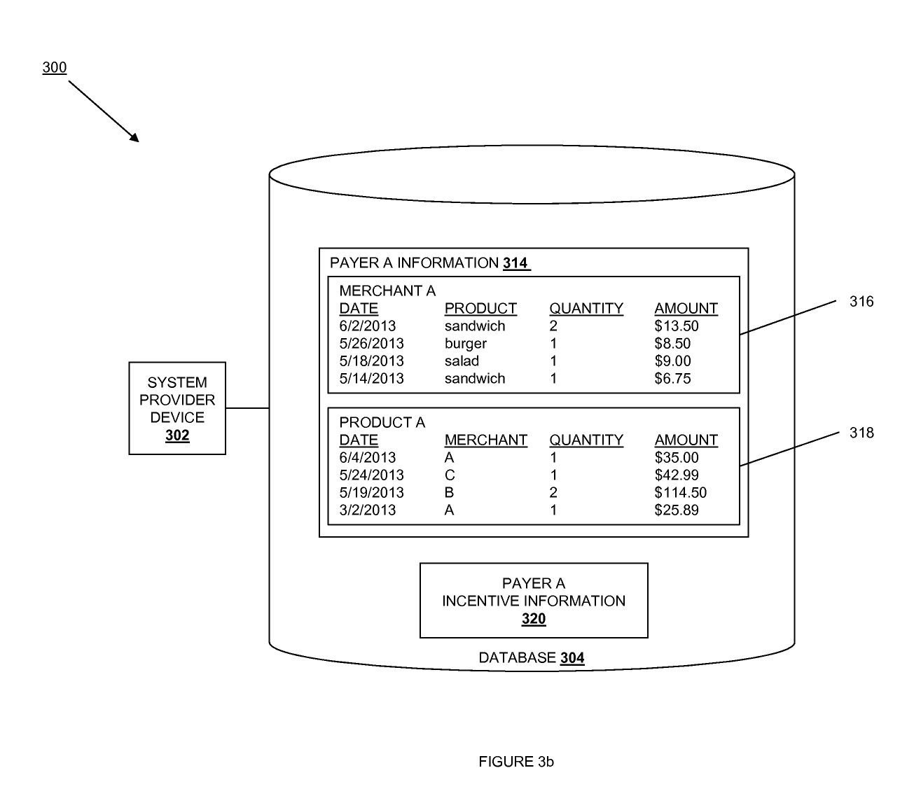

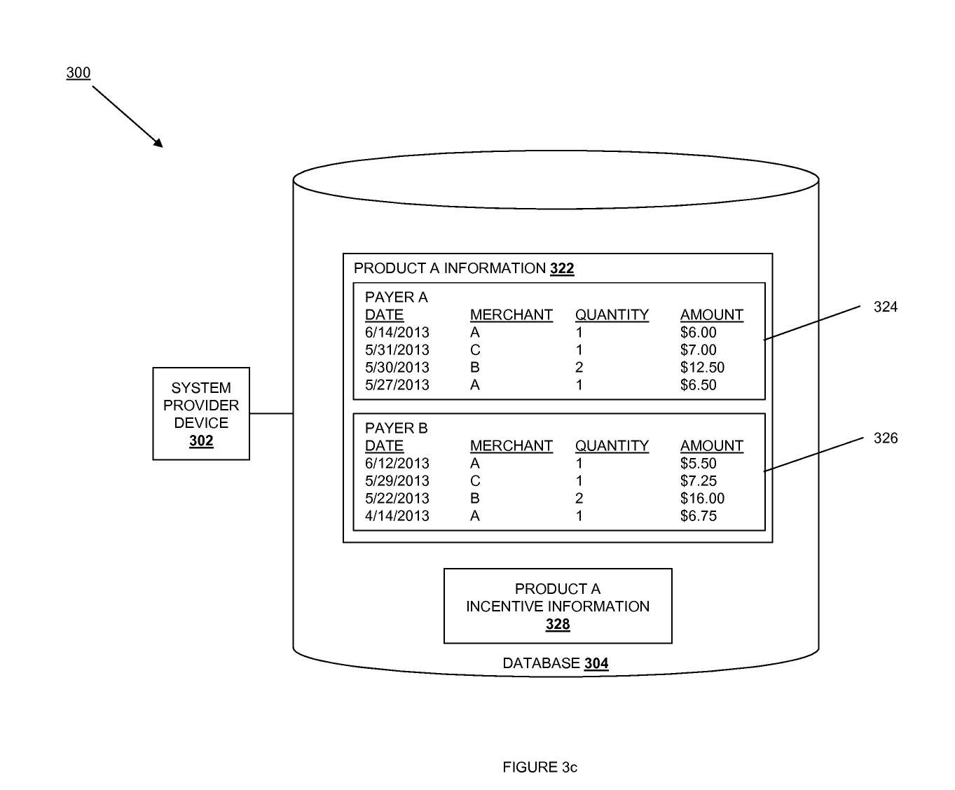

FIG. 3a illustrates a purchase incentivizing system 300 including a system provider device 302, which may be the system provider device 208 discussed above with reference to FIG. 2, coupled to a database 304, which may be the database 210 discussed above with reference to FIG. 2. In the embodiment illustrated in FIG. 3a, the database 304 includes merchant A information 306 (e.g., information about a particular merchant included in the merchant information 210a discussed above with reference to FIG. 2) that includes associated purchase information 308 corresponding to a payer A, and purchase information 310 corresponding to a payer B. As can be seen in the illustrated embodiment, the purchase information 308 corresponding to payer A includes, for each purchase made by payer A, a date of purchase, a product purchased, a quantity purchased, and a purchase amount. Similarly, the purchase information 310 corresponding to payer B includes, for each purchase made by payer B, a date of purchase, a product purchased, a quantity purchased, and a purchase amount. The example of the purchase information 308 and 310 has been provided for clarity of illustration and discussion, and one of skill in the art will recognize that purchase information corresponding to a payer may include a variety of other purchase information known in the art (e.g., rather than detailing single products for each purchase, a detailed list of a plurality of products associated with each purchase may be provided.) The database 304 also includes merchant A incentive information 312 (e.g., information for one or more incentive programs associated with merchant A in the incentive information 210d discussed above with reference to FIG. 2).

At block 104, the system provider device 302 may review the merchant A incentive information 312 and determine whether the purchase information 308 corresponding to payer A or the purchase information 310 corresponding to payer B qualifies for an incentive associated with merchant A. For example, the system provider device 302 may determine that payer A or payer B has qualified for an incentive if a number of purchases are made by payer A or payer B in a predetermined time period (e.g., by reviewing the dates of purchases in the purchase information 308 or 310 for a number of purchases within the predetermined time period.) In another example, the system provider device 302 may determine that payer A or payer B has qualified for an incentive if a predetermined number of products are purchased by payer A or payer B (e.g., by reviewing the products purchased and quantity purchased in the purchase information 308 or 310 for the predetermined number of total products or a predetermined number of a particular product.) In another example, the system provider device 302 may determine that payer A or payer B has qualified for an incentive if a predetermined amount of purchases are made by payer A or payer B (e.g., by reviewing the purchase amounts in the purchase information 308 or 310 for the predetermined amount of purchases.)

In an embodiment, for each payer associated with the payer information 210b, the system provider device 208 may periodically (e.g., at predetermined times or in response to an instruction) review the payer information for that payer to determine whether a subset of the purchases corresponding to the purchase information associated with that payer information qualifies for an incentive. For example, for a particular payer, the system provider device 208 may retrieve the incentive information 210d associated with that particular payer, and then review the purchase information associated with that particular payer in the payer information 210b to determine whether purchases by that payer from one or more merchants or merchant locations (or of a product) qualify for an incentive included in the incentive information 210d.

FIG. 3b illustrates the purchase incentivizing system 300 including the system provider device 302 coupled to the database 304. In the embodiment illustrated in FIG. 3b, the database 304 includes payer A information 314 (e.g., information about a particular payer included in the payer information 210b discussed above with reference to FIG. 2) that includes associated purchase information 316 corresponding to a merchant A, and purchase information 318 corresponding to a product A. As can be seen in the illustrated embodiment, the purchase information 316 corresponding to merchant A includes, for each purchase made by payer A from merchant A, a date of purchase, a product purchased, a quantity purchased, and a purchase amount. Similarly, the purchase information 318 corresponding to product A includes, for each purchase made by payer A of product A, a date of purchase, a merchant from which the purchase was made, a quantity purchased, and a purchase amount. The example of the purchase information 316 and 318 has been provided for clarity of illustration and discussion, and one of skill in the art will recognize that purchase information corresponding to a merchant and a product may include a variety of other purchase information known in the art (e.g., rather than detailing single products for each purchase, a detailed list of a plurality of products associated with each purchase from a merchant may be provided.) The database 304 also includes payer A incentive information 320 (e.g., information for one or more incentive programs associated with payer A in the incentive information 210d discussed above with reference to FIG. 2).

At block 104, the system provider device 302 may review the payer A incentive information 312 and determine whether the purchase information 316 corresponding to merchant A or the purchase information 318 corresponding to product A qualifies for an incentive associated with payer A. For example, the system provider device 302 may determine that payer A has qualified for an incentive if a number of purchases are made by payer A from merchant A, or a number of product A has been purchased by payer A, in a predetermined time period (e.g., by reviewing the dates of purchases in the purchase information 316 or 318 for a number of purchases within the predetermined time period.) In another example, the system provider device 302 may determine that payer A has qualified for an incentive if a predetermined number of products are purchased by payer A from merchant A, or a predetermined number of product A are purchased by payer A (e.g., by reviewing the products purchased and/or quantity purchased in the purchase information 316 or 318 for the predetermined number of total products from merchant A, the predetermined number of a particular product from merchant A, or the predetermined number of product A.) In another example, the system provider device 302 may determine that payer A has qualified for an incentive if a predetermined amount of purchases are made by payer A from merchant A, or by payer A of product A (e.g., by reviewing the purchase amounts in the purchase information 316 or 318 for the predetermined amount of purchases.)

In an embodiment, for each product and/or service associated with the product/service information 210c, the system provider device 208 may periodically (e.g., at predetermined times or in response to an instruction) review the product/service information for that product and/or service to determine whether a subset of the purchases corresponding to the purchase information associated with that product/service information qualifies for an incentive. For example, for a particular product and/or service, the system provider device 208 may retrieve the incentive information 210d associated with that particular product and/or service, and then review the purchase information associated with that particular product and/or service in the product/service information 210c to determine whether purchases of that product and/or service by any payer qualify for an incentive included in the incentive information 210d.

FIG. 3c illustrates the purchase incentivizing system 300 including the system provider device 302 coupled to the database 304. In the embodiment illustrated in FIG. 3c, the database 304 includes product A information 322 (e.g., information about a particular product included in the product information 210c discussed above with reference to FIG. 2) that includes associated purchase information 324 corresponding to a payer A, and purchase information 326 corresponding to a payer B. As can be seen in the illustrated embodiment, the purchase information 324 corresponding to payer A includes, for each purchase made by payer A of product A, a date of purchase, a merchant from which the purchase was made, a quantity purchased, and a purchase amount. Similarly, the purchase information 326 corresponding to payer B includes, for each purchase made by payer B of product A, a date of purchase, a merchant from which the purchase was made, a quantity purchased, and a purchase amount. The example of the purchase information 324 and 326 has been provided for clarity of illustration and discussion, and one of skill in the art will recognize that purchase information corresponding to a product and/or service may include a variety of other purchase information known in the art. The database 304 also includes product A incentive information 328 (e.g., information for one or more incentive programs associated with product A in the incentive information 210d discussed above with reference to FIG. 2).

At block 104, the system provider device 302 may review the product A incentive information 328 and determine whether the purchase information 324 corresponding to payer A or the purchase information 326 corresponding to payer B qualifies for an incentive associated with product A. For example, the system provider device 302 may determine that payer A or payer B has qualified for an incentive if a number of purchases of product A are made by payer A or payer B in a predetermined time period (e.g., by reviewing the dates of purchases in the purchase information 308 or 310 for a number of purchases within the predetermined time period.) In another example, the system provider device 302 may determine that payer A or payer B has qualified for an incentive if a predetermined number of product A are purchased by payer A or payer B (e.g., by reviewing the quantity purchased in the purchase information 324 or 326 for the predetermined number of purchases of product A.) In another example, the system provider device 302 may determine that payer A or payer B has qualified for an incentive if a predetermined amount of purchases of product A are made by payer A or payer B (e.g., by reviewing the purchase amounts in the purchase information 324 or 326 for the predetermined amount of purchases.)

Thus, in an embodiment of block 104 of the method 100, the system provider device determines a plurality of different subsets of purchases from particular merchants, from particular merchant locations, or of a particular product by particular payers that qualify for incentives. As such, the system provider device may determine that a first payer qualifies for one or more incentives based on their purchases from a particular merchant, based on their purchases from one or more merchants at a merchant location, based on their purchases of a product; that a second payer qualifies for one or more incentives based on their purchases from a particular merchant, based on their purchases from one or more merchants at a merchant location, based on their purchases of a product; and so on.

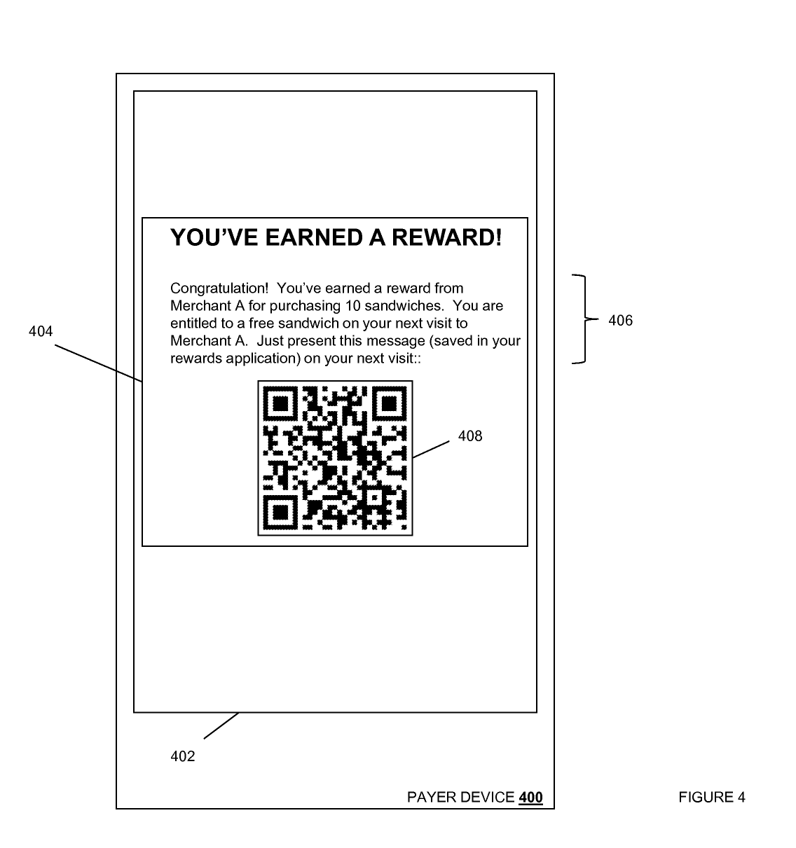

Referring now to FIGS. 1, 2, and 4, the method 100 then proceeds to block 106 where incentives are sent to payer devices associated with payers that qualify for incentives. In an embodiment, for each payer associated with the subset of purchases that were determined to qualify for an incentive at block 104, the system provider device 208 may retrieve that incentive and send the incentive over the network 206 to a payer device associated with that payer. FIG. 4 illustrates an embodiment of a payer device 400, which may be either of the payer devices 202a or 202b discussed above with reference to FIG. 2, including a display 402 that is displaying an incentive 404 received from the system provider device 208. In the illustrated embodiment, the incentive 404 includes information 406 about a merchant that the incentive 404 is associated with and the purchase activity that resulted in the incentive 404, and an incentive redemption code 408. For example, at blocks 104 and 106 in the illustrated embodiment, the system provider device 208 may determine that the payer associated with the payer device 400 qualifies for an incentive of a free sandwich from merchant A in response to determining that the payer purchased ten sandwiches from merchant A. In response, the system provider device 208 may create the quick response (QR) code incentive redemption code 408 and send the incentive 404 over the network 206 to the payer device 400. In addition, the system provider device 208 may send the QR code incentive redemption code 408 to the merchant device 204 and/or store the QR code incentive redemption code 408 in the merchant information 210a associated with merchant A and/or the payer information 210b for the payer associated with the payer device 400. Furthermore, the incentive 404 and/or the redemption code 408 may be stored on the payer device 400 (e.g., associated with a rewards application on the payer device 400 as illustrated.)

While the illustrated embodiment is directed to an incentive resulting from a payer purchasing a predetermined number of a specific product from a merchant, any of the examples of incentives discussed above, as well as any other incentives known in the art, may result in an incentive similar to the incentive 404. For example, incentives for any purchases from a merchant by a payer may be provided, incentives for any purchases from a merchant location (e.g., a mall, a shopping district, a city, etc.) by a payer may be provided, incentives for any purchases of a product by a payer may be provided, etc.

In addition, while one of skill in the art will recognize the incentive 404 as a text message or other short message service (SMS) message, the incentive may 404 may be provided in any manner such as, for example, through an email, through an application running on the payer device 400, etc. Furthermore, rather than the QR code incentive redemption code 408 of the illustrated embodiment, web links or other redemption codes may be sent to the payer device 400 to allow the payer associated with the payer device 400 to redeem the incentive. In some embodiments, payer information about the payer associated with the payer device 400 may be sent to the merchant so that the redemption code 408 is unnecessary (e.g., the payer associated with the payer device 400 may redeem the incentive by providing identification to the merchant.)

Thus, systems and methods have been described in which a purchase incentivizing system provider manages incentive programs associated with a plurality of merchants. The purchase incentivizing system provider tracks purchases between any number of payers and any number of merchants (or by any number of payers of any number of products), determines whether the payers qualify for incentives, and sends those incentives to the payers to incentivize purchases from those merchants (or of those products.) The purchase incentivizing system provider offloads the management of purchase incentivizing programs from the merchants and product providers and, in some cases, may operate incentive programs involving merchants and product providers without their participation (e.g., a financial account provider may incentive purchases of products or from a merchant or merchants to increase spending related to a particular financial account of a payer.) The purchase incentivizing systems and methods discussed herein provide for institution of purchase incentive programs with granularity in payer purchase knowledge, accurate and up-to-date tracking of payer reward progress, and targeting of payers based on prior purchases and/or outside of current transactions.

Referring now to FIGS. 1, 2, 5a, and 5b, the method 100 may then proceed to block 108 where subsets of purchases are determined to be close to qualifying for incentives. In an embodiment, the system provider device 208 may use any or all of the merchant information 210a, the payer information 210b, the product/service information 210c, and the incentive information 210d to determine whether a subset of purchases by a payer is close to qualifying for an incentive. The determination of whether a payer is close to qualifying for an incentive may be made based on that payer being within a predetermined level of purchases from qualifying for an incentive, and that predetermined level may be provided by merchants, product providers, the purchase incentivizing system provider, and/or any other entity involved in the purchase incentive system.

In an embodiment, for each merchant associated with the merchant information 210a, the system provider device 208 may periodically (e.g., at predetermined times or in response to an instruction) review the merchant information for that merchant to determine whether a subset of the purchases corresponding to the purchase information associated with that merchant information is close to qualifying for an incentive. For example, for a particular merchant, the system provider device 208 may retrieve the incentive information 210d associated with that particular merchant, and then review the purchase information associated with that particular merchant in the merchant information 210a to determine whether purchases from that merchant by any payer are within a predetermined level of qualifying for an incentive included in the incentive information 210d.

In an embodiment, referring back to FIG. 3a, the system provider device 302 may review the merchant A incentive information 312 and determine whether the purchase information 308 corresponding to payer A or the purchase information 310 corresponding to payer B is within a predetermined level of qualifying for an incentive associated with merchant A. For example, the system provider device 302 may determine that payer A or payer B are close to qualifying for an incentive if a number of purchases made by payer A or payer B in a predetermined time period are within a predetermined number of purchases from qualifying for an incentive. In another example, the system provider device 302 may determine that payer A or payer B are close to qualifying for an incentive if a number of products purchased by payer A or payer B are within a predetermined number of purchased products from qualifying for an incentive. In another example, the system provider device 302 may determine that payer A or payer B are close to qualifying for an incentive if an amount of purchases made by payer A or payer B is within a predetermined amount of qualifying for an incentive.

In an embodiment, for each payer associated with the payer information 210b, the system provider device 208 may periodically (e.g., at predetermined times or in response to an instruction) review the payer information for that payer to determine whether a subset of the purchases corresponding to the purchase information associated with that payer information is close to qualifying for an incentive. For example, for a particular payer, the system provider device 208 may retrieve the incentive information 210d associated with that particular payer, and then review the purchase information associated with that particular payer in the payer information 210b to determine whether purchases by that payer from one or more merchants or merchant locations (or of a product) is within a predetermined level of qualifying for an incentive included in the incentive information 210d.

In an embodiment, referring back to FIG. 3b, the system provider device 302 may review the payer A incentive information 312 and determine whether the purchase information 316 corresponding to merchant A or the purchase information 318 corresponding to product A is close to qualifying for an incentive associated with payer A. For example, the system provider device 302 may determine that payer A is close to qualifying for an incentive if a number of purchases made by payer A from merchant A, or a number of product A purchased by payer A, within a predetermined time period are within a predetermined number of purchases of qualifying for an incentive. In another example, the system provider device 302 may determine that payer A is close to qualifying for an incentive if a number of products purchases by payer A from merchant A is within a predetermined number of purchases of qualifying for an incentive, or a number of product A purchased by payer A is within a predetermined number of purchases of product A of qualifying for an incentive. In another example, the system provider device 302 may determine that payer A is close to qualifying for an incentive if an amount of purchases are made by payer A from merchant A that are within a predetermined amount of qualifying for an incentive, or an amount of purchases by payer A of product A are within a predetermined amount of qualifying for an incentive.

In an embodiment, for each product and/or service associated with the product/service information 210c, the system provider device 208 may periodically (e.g., at predetermined times or in response to an instruction) review the product/service information for that product and/or service to determine whether a subset of the purchases corresponding to the purchase information associated with that product/service information is close to qualifying for an incentive. For example, for a particular product and/or service, the system provider device 208 may retrieve the incentive information 210d associated with that particular product and/or service, and then review the purchase information associated with that particular product and/or service in the product/service information 210c to determine whether purchases of that product and/or service by any payer is within a predetermined level of qualifying for an incentive included in the incentive information 210d.

In an embodiment, referring back to FIG. 3c, the system provider device 302 may review the product A incentive information 328 and determine whether the purchase information 324 corresponding to payer A or the purchase information 326 corresponding to payer B is close to qualifying for an incentive associated with product A. For example, the system provider device 302 may determine that payer A or payer B is close to qualifying for an incentive if a number of purchases of product A made by payer A or payer B in a predetermined time period is within a predetermined number of purchases of qualifying for an incentive. In another example, the system provider device 302 may determine that payer A or payer B is close to qualifying for an incentive if a number of product A purchased by payer A or payer B is within a predetermined number of purchases of product A of qualifying for an incentive. In another example, the system provider device 302 may determine that payer A or payer B is close to qualifying for an incentive if an amount of purchases of product A made by payer A or payer B is within a predetermined amount of qualifying for an incentive.

Thus, in an embodiment of block 108 of the method 100, the system provider device determines a plurality of different subsets of purchases from particular merchants from particular merchant locations, or of particular products by particular payers that are close to qualifying for incentives from those particular merchants. As such, the system provider device may determine that a first payer is close to qualifying for one or more incentives based on their purchases from a particular merchant, based on their purchases from one or more merchants at a merchant location, based on their purchases of a product; that a second payer is close to qualifying for one or more incentives based on their purchases from a particular merchant, based on their purchases from one or more merchants at a merchant location, based on their purchases of a product; and so on.

The method 100 then proceeds to block 110 where messages are sent to payer devices associated with payers that are close to qualifying for incentives. In an embodiment, for each merchant (or merchant location, or product provider) associated with a payer that was determined to have a subset of purchases that were close to qualifying for an incentive associated with that merchant, the system provider device 208 may send a message over the network 206 to the merchant device 204 informing that merchant that that payer is close to qualifying for the incentive. In response to that message, the merchant may instruct the system provider device 208 (e.g., over the network using the merchant device 204) to notify the payer that they are close to qualifying for an incentive (e.g., by sending a message over the network 206 to the payer devices associated with payers that are close to qualifying for the incentive.) In other embodiments, at block 110, the system provider device 208 may send messages to payer device associated with payers that are close to qualifying for incentives without contacting the merchant associated with those incentives.

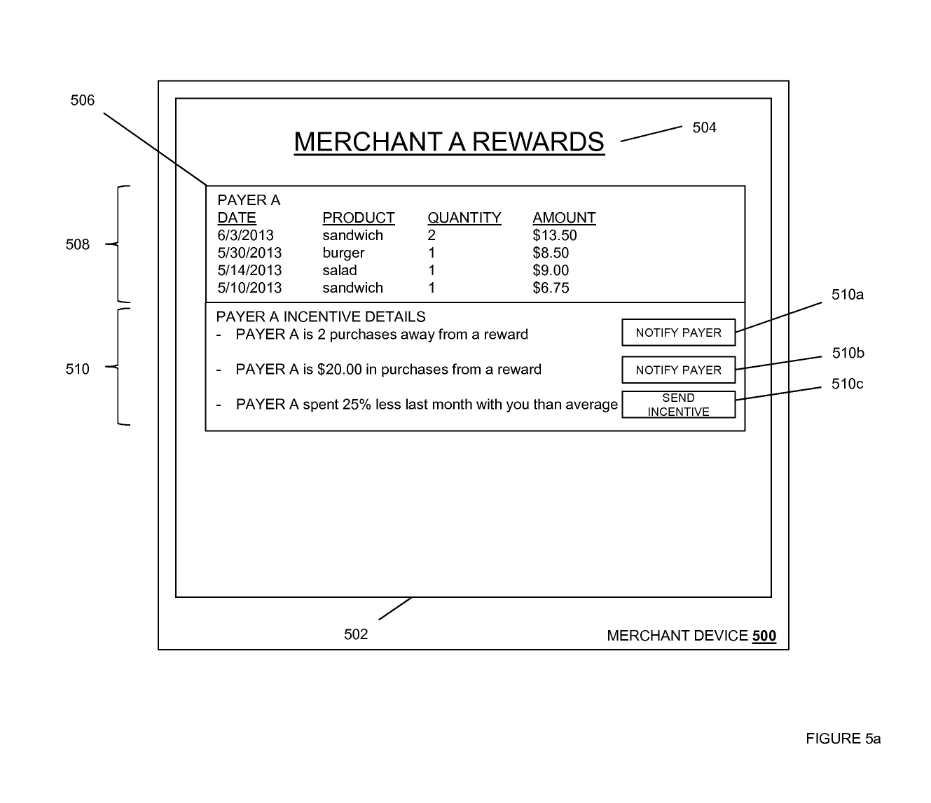

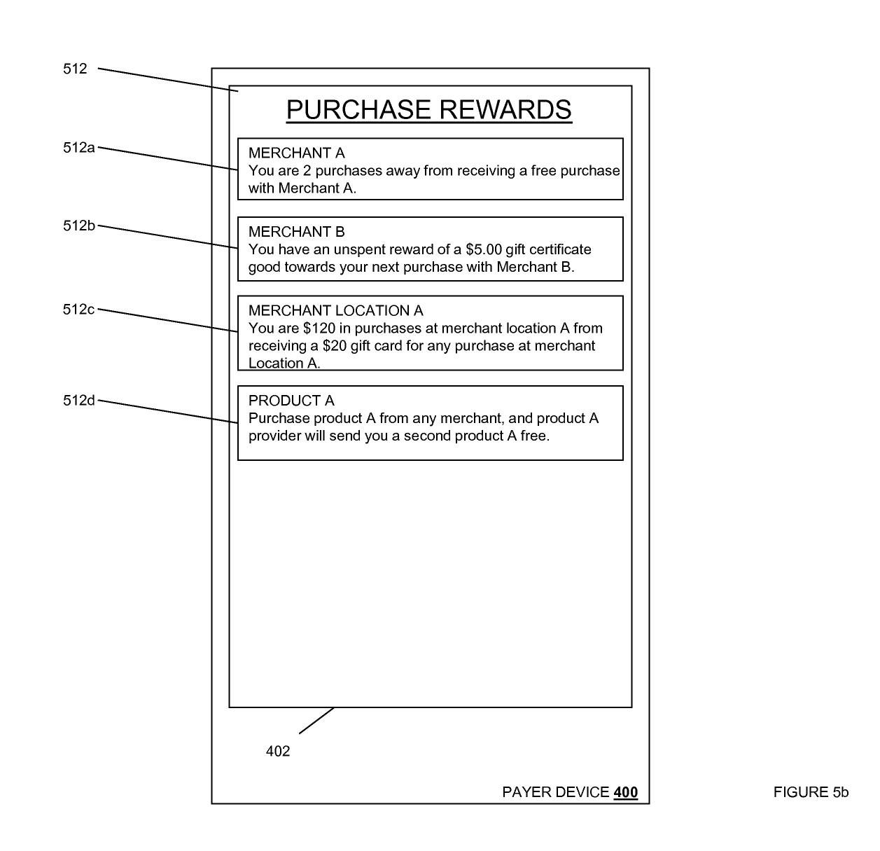

For example, FIG. 5a illustrates a merchant device 500, which may be the merchant device 204 discussed above with reference to FIG. 2, including a display 502 displaying a message screen 504 received from the system provider device 208 by a merchant device 500 associated with a merchant A. In the illustrated embodiment, the message screen 504 includes a payer A notification 506 that includes a payer A purchasing information section 508 detailing the purchasing information for a payer A that is associated with the merchant A, and a payer A incentive details section 510 including details about the incentives offered by the merchant A and associated with the payer A. The payer A incentive details section 510 includes information about incentives that the payer A is close to qualifying for (e.g., as determined by the system provider device 208 at block 110 of the method 100), along with corresponding notify payer inputs 510a and 510b that the merchant A may select (e.g., using an input device coupled to the merchant device 500) to send an instruction to the system provider device 208 to notify the payer A that they are close to qualifying for an incentive with the merchant A. In the illustrated example, the information about the incentives that the payer A is close to qualifying for includes information about a number of purchases the payer A is away from qualifying for an incentive with the merchant A, and an amount of purchases the payer A is away from qualifying for an incentive with the merchant A. However, merchants, product providers, or other incentive program providing entities may be notified of any purchase information that is within a purchase level of qualifying for an incentive with those merchants.

FIG. 5b illustrates the payer device 400, discussed above with reference to FIG. 4, with the display 402 displaying a message screen 512 includes information received from the system provider device 208 (e.g., in response to the merchant selecting the notify payer inputs 510a or 510b, in response to the system provider device 208 determining that the payer associated with the payer device 400 is close to qualifying for an incentive, etc.) In an embodiment, the message screen 512 may be part of a rewards application on the payer device 400 that communicates with the system provider device 208 over the network 206 to track incentives earned and incentive progress for the payer associated with the payer device 400 for any number of merchants, merchant locations, products, or other purchase incentive system entities. The message screen 512 includes a plurality of messages 512a, 512b, 512c, and 512d.

In the example provided, the message 512a includes a notification that the payer associated with the payer device 400 is two purchases away from earning an incentive (a free purchase in the illustrated embodiment) with merchant A, the message 512b includes a notification that the payer associated with the payer device 400 has an unused incentive (a $5.00 gift certificate in the illustrated embodiment) with merchant B, the message 512c includes a notification that the payer associated with the payer device 400 is a purchase amount away from earning an incentive ($120 away from earning a $20 gift card in the illustrated embodiment) at a merchant location A (e.g., at a mall, in a shopping district, etc.), and the message 512d includes a notification that the payer associated with the payer device 400 is one purchase of product A away from earning an incentive (a free product A in the illustrated embodiment) from a product provider (e.g., the provider of product A.)

While a few examples of the incentive messages that may be provided to a payer device associated with a payer have been provided, the system provider device 208 may provide a payer device with any information associated with the purchase incentivizing system, and particularly any information that may incentivize the payer associated with that payer device to make a purchase. One of skill in the art will recognize that reminding a payer of incentives they have earned, or notifying a payer that they are close to earning an incentive, is likely to cause that payer to make a purchase they might otherwise put off.

Referring now to FIGS. 1, 2, and 5a, the method 100 may then proceed to block 112 where payers are determined to be spending less with merchants or product providers (or at merchant locations), and those merchants or product providers are notified. In an embodiment, the system provider device 208 may use any or all of the merchant information 210a, the payer information 210b, the product/service information 210c, and the incentive information 210d to determine whether a particular payer is spending less with a particular merchant. For example, the system provider device 208 may review subsets of purchases by payers (e.g., from merchants, merchant locations, or of products) over different time periods and compare those subsets to determine changes in spending behavior.

For example, the system provider device 208 may review a first subset of purchases by a payer from a merchant in a first time period (e.g., a particular month), and then review a second subset of purchases by that payer from that merchant in a second time period (e.g., the following month) and determine whether that payer is spending more, less, or relatively the same amount with that merchant. Similarly, the system provider device 208 may review a first subset of purchases by a payer at a merchant location in a first time period (e.g., a particular month), and then review a second subset of purchases by that payer at that merchant location in a second time period (e.g., the following month) and determine whether that payer is spending more, less, or relatively the same amount at that merchant location. Similarly, the system provider device 208 may review a first subset of purchases by a payer of a product in a first time period (e.g., a particular month), and then review a second subset of purchases by that payer of that product in a second time period (e.g., the following month) and determine whether that payer is spending more, less, or relatively the same amount on that product. While a few examples have been provided, any purchasing behavior of payers may be monitored to determine any purchasing metric that is desired at block 112 of the method 100.

Referring back to FIG. 5a, the message screen 504 received from the system provider device 208 by a merchant device 500 associated with a merchant A may include information related to the purchasing behavior determined at block 112 of the method 100. In the illustrated embodiment, the payer A incentive details section 510 includes information about the purchasing behavior of the payer A with the merchant A (e.g., a notification that payer A spent 25% less the previous month than in an average month), along with a send incentive input 510c that the merchant may select to instruct the system provider device 208 to send an incentive (e.g., a rebate for a product, a gift certificate, etc.) to incentivize the payer A to make a purchase.

The method 100 then proceeds to block 114 where incentives are sent to particular payers that are spending less with particular merchants. In an embodiment, the system provider device 208 may send incentives (e.g., similar to those illustrated in FIG. 4 or 5b) to payer devices associated with payers that have been determined to be spending less (with merchants, at merchant locations, or on products) in response to the selection of the send incentive input 510c, or simply in response to determining that that payer is spending less with a merchant, at a merchant location, or on a product.

In some embodiments, the system provider device 208 may leverage knowledge of the complete purchasing behavior of payers to offer merchants the ability to offer incentives. For example, the system provider device 208 may review a complete purchase history of a payer across multiple merchants, merchant locations, and/or products to determine if a payer has stopped making purchases with a particular merchant, has switched to making purchases of a product to a different merchant, has stopped making purchases at a particular merchant location, has switched to making purchases of a product to a different merchant location, has stopped purchasing a product, has switched to purchasing a product from a different product provider, etc. The system provider device may then notify a merchant, merchant location, or product provider, about that payer purchasing behavior in order to allow an incentive to be provided to the payer to revert back to their previous purchasing behavior. For example, the system provider device 508 inform a merchant that a payer has switched to making purchases from a competing merchant, and may provide that merchant the ability to offer an incentive to that payer to revert back to purchasing from that merchant.

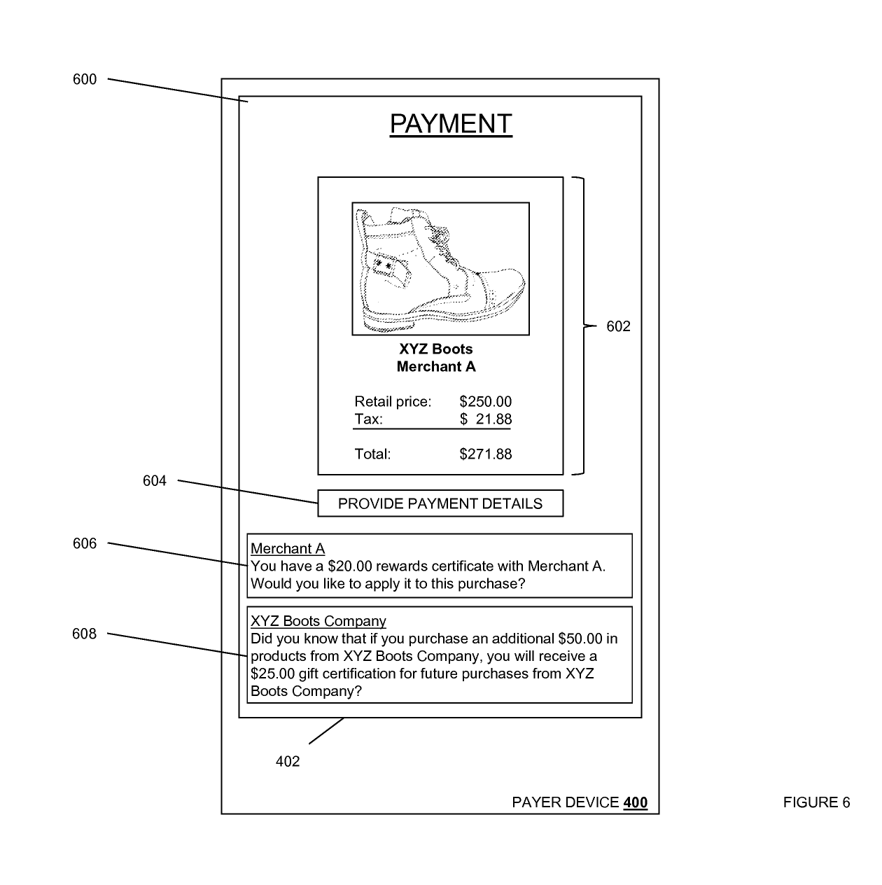

In some embodiments, the system provider device 208 may communicate over the network 206 with payer devices during purchasing situations. For example, FIG. 6 illustrates the payer device 400, discussed above with reference to FIG. 4, with the display 402 displaying a payment screen 600. The payment screen 600 includes a purchase details section 602 that, in the illustrated embodiment, includes details of a purchase including an image of the product being purchased and purchase amounts. The payment screen 600 also includes a payment details input 604 that the payer may select to provider payment details such as, for example, a payment account and other information for making a purchase. In an embodiment, in response to determining that the payer associated with the payer device 400 is making a purchase of the product in the purchase details section 602 from a merchant A, the system provider device 208 has searched the database 208 to determine any incentives associated with the payer and that product or the merchant A. In response, the system provider device 208 has provided messages 606 and 608 on the payment screen 600. The message 606 in the illustrated embodiment includes information informing the payer associated with the payment device 400 that that payer has an unused incentive (a $20 rewards certificate) with the merchant A, and gives that payer the option to apply that incentive to the purchase of the product. The message 608 in the illustrated embodiment includes information informing the payer associated with the payment device 400 that that payer is close to qualifying for an incentive (a $25 gift certificate if $50 more is spent on products from the product provider) with the product provider of the product in the purchase details 602. While a few examples have been provided, the system provider device 208 may send payer devices any purchase incentivizing system information desired during the purchase of a product or service while remaining within the scope of the present disclosure

Thus, systems and methods for incentivizing purchases have been described that allow a third party purchase incentivizing system provider to track the purchases from a plurality of merchants or merchant locations, or of a product, by a plurality of payers to allow those payers to be incentivized not only in response to earning an incentive, but also to earn that incentive by making purchases, or in response to reduced purchasing by the payers In some embodiments, the incentivizing is facilitated by a purchase incentivizing system provider that also operates to provide payment services between the merchants and payers so that a variety of purchasing behavior of the payers other than purchases with a particular merchant may be leveraged to determine how and when to incentivize the payers.

In one specific example of a purchase incentivizing system, a purchase incentivizing system provider may manage the incentive programs for a plurality of merchant. Some of the plurality of merchants may provide the incentive information for their incentive program(s) to the purchase incentivizing system provider, and the purchase incentivizing system provider may determine the incentive information for the incentive program(s) for others of the plurality of merchants. For merchants for whom the purchase incentivizing system provider determined the incentive information for corresponding incentive programs, those merchants may be provided the ability to “opt in” to the incentivizing program. For example, the purchase incentivizing system provider may provide incentives to payers to make purchases with those merchants (e.g., by crediting their purchase accounts with merchant specific funds for those merchants) without those merchant's knowledge. Those merchants may then be shown how such incentivizing may increase sales, and given the option to opt in to the incentivizing program, modify the incentivizing information, etc.

In another specific example of the purchase incentivizing system, a purchase incentivizing program may be provided for a city by the system provider. For example, the city of Las Vegas, Nev., may wish to incentivize users to come to the city and spend money. In order to implement this incentivizing system, the purchase incentivizing system may then track purchases by users in the city of Las Vegas. In some embodiments, any user making a purchase in the city of Las Vegas may be tracked. However, the incentivizing program may be directed at incentivizing users who do not live in the city of Las Vegas to visit the city, and thus only users known to live outside of the city of Las Vegas (e.g., a predetermined distance from the city of Las Vegas) may have their purchases tracked or incentivized. In some embodiments, purchases from any merchant in the city of Las Vegas may be tracked, while in other embodiments, purchases at specific merchants (e.g., merchant belonging to the Las Vegas Chamber of Commerce) or merchant types (e.g., casinos) may be tracked. In response to a user making purchases within the city of Las Vegas that reach a predetermined level (e.g., as set by the city of Las Vegas) according to the purchase incentivizing program, the incentives may be offered (e.g., tickets to any of a plurality of shows in response to purchases totaling $500 or more.) As discussed above, there is no need for merchants to opt in to such a city-based purchase incentivizing system. However, merchant opt-in to the purchase incentivizing system may provide specific benefits to the merchants. For example, a user arriving in the city of Las Vegas may be detected, and that arrival reported to any merchants that are part of the purchase incentivizing system, allowing those merchants to provide incentives based on a user arriving in their city (rather than having to wait until the user check's in, for example, via a merchant specific identification card as in conventional incentivizing systems.)

In another specific example of the purchase incentivizing system, a purchase incentivizing program may be provided for a product or merchant group by the system provider. For example, purchase incentivizing systems may be provided for a shoe manufacturer (e.g., Nike®), or a merchant specific group (e.g., the National Catholic Business Directory) that includes a plurality of merchants as its members. Such purchases incentivizing systems may work substantially as discussed above, but with the tracking of purchases by the user of a product or products of the shoe manufacturer from any merchant, or with the tracking of purchases by the user from any of the merchants that are members of the merchant group. In some embodiments, such incentivizing systems may operate to incentivize a user away from a particular merchant to another merchant (e.g., the purchase incentivizing system may inform a user that shoes may be cheaper at one merchant relative to another, or inform a user than a particular merchant in the merchant group is having a sale). However, it will likely be beneficial in such purchase incentivizing systems to include rules that do not “pit” merchants against each other, and thus such purchase incentivizing systems may operate in a “merchant-neutral” fashion that may incentivize product purchase or purchases from merchants based only on neutral factors such as proximity to the user, product availability, etc.

The specific examples above illustrate how the purchase incentivizing system provides benefits over conventional purchase incentivizing systems that have traditionally been merchant-based (i.e., the monitoring of purchases at a particular merchant and providing incentives based on those purchases.) In one example, the use of a payment provider network that tracks spending of users across one or more financial accounts allows purchase incentivizing programs to be created that can tie together multiple merchants by location (e.g., the city of Las Vegas), product (e.g., Nike® shoes), and/or a variety of other purchase details, extending traditional purchase incentive programs to cover purchase patterns that were not previously available. Thus, purchase incentive programs may be designed that are directed specifically to the benefit of the consumer, without even the need for merchant opt-in.

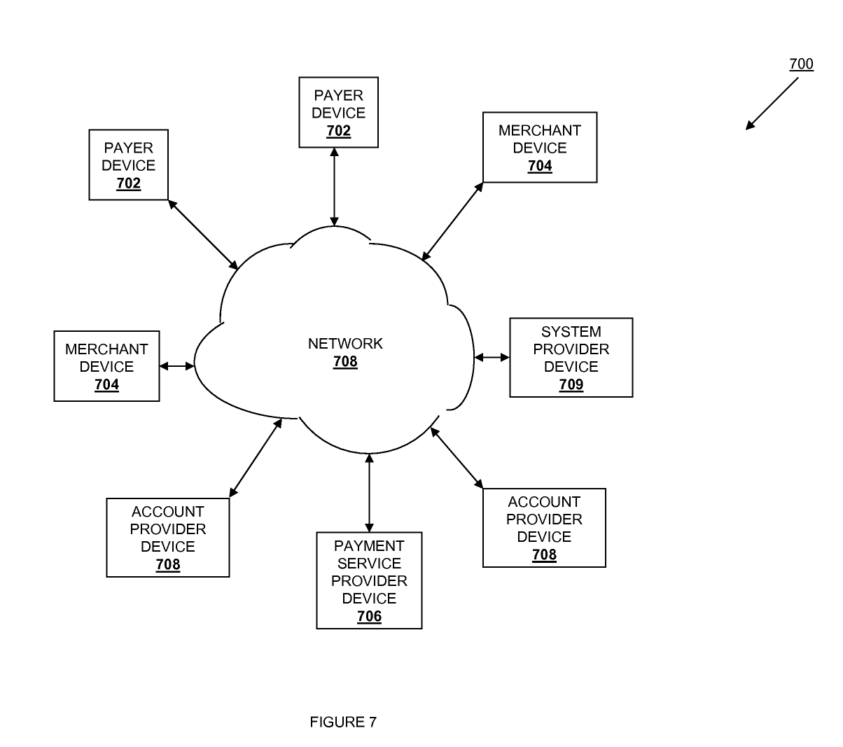

Referring now to FIG. 7, an embodiment of a network-based system 700 for implementing one or more processes described herein is illustrated. As shown, network-based system 700 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 7 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 700 illustrated in FIG. 7 includes a plurality of payer devices 702, a plurality of merchant devices 704, a payment service provider device 706, a plurality of financial account holder devices 708, and/or a system provider device 709 in communication over a network 710. Any of the payer devices 702 may be the payer devices 202a, 202b, and/or 400, discussed above. The merchant devices 704 may be the merchant devices 204 and/or 500 discussed above and may be operated by the merchants discussed above. The payment service provider device 706 may be the payment service provider devices discussed above and may be operated by a payment service provider such as, for example, PayPal Inc. of San Jose, Calif. The financial account provider devices 708 may be the financial account provider devices discussed above and may be operated by the financial account providers discussed above such as, for example, credit card account providers, bank account providers, savings account providers, and a variety of other account providers known in the art. The system provider device 709 may be the system provider devices 208 and/or 302 discussed above and may be operated by the system providers discussed above.

The payer devices 702, merchant devices 704, payment service provider device 706, account provider devices 708, and/or system provider device 709 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 700, and/or accessible over the network 710.

The network 710 may be implemented as a single network or a combination of multiple networks. For example, in various embodiments, the network 710 may include the Internet and/or one or more intranets, landline networks, wireless networks, and/or other appropriate types of networks.

The payer devices 702 may be implemented using any appropriate combination of hardware and/or software configured for wired and/or wireless communication over network 710. For example, in one embodiment, the payer devices 702 may be implemented as a personal computer of a user in communication with the Internet. In other embodiments, the payer devices 702 may be a smart phone, personal digital assistant (PDA), laptop computer, and/or other types of computing devices.

The payer devices 702 may include one or more browser applications which may be used, for example, to provide a convenient interface to permit the payer to browse information available over the network 710. For example, in one embodiment, the browser application may be implemented as a web browser configured to view information available over the Internet.

The payer devices 702 may also include one or more toolbar applications which may be used, for example, to provide user-side processing for performing desired tasks in response to operations selected by the payer. In one embodiment, the toolbar application may display a user interface in connection with the browser application.

The payer devices 702 may further include other applications as may be desired in particular embodiments to provide desired features to the payer devices 702. In particular, the other applications may include a payment application for payments assisted by a payment service provider through the payment service provider device 706. The other applications may also include security applications for implementing user-side security features, programmatic user applications for interfacing with appropriate application programming interfaces (APIs) over the network 710, or other types of applications. Email and/or text applications may also be included, which allow the payer to send and receive emails and/or text messages through the network 710. The payer devices 702 includes one or more user and/or device identifiers which may be implemented, for example, as operating system registry entries, cookies associated with the browser application, identifiers associated with hardware of the payer devices 702, or other appropriate identifiers, such as a phone number. In one embodiment, the user identifier may be used by the payment service provider device 706 and/or account provider devices 708 to associate the payer with a particular account as further described herein.

The merchant devices 704 may be maintained, for example, by a conventional or on-line merchant, conventional or digital goods seller, individual seller, and/or application developer offering various products and/or services in exchange for payment to be received conventionally or over the network 710. In this regard, the merchant devices 704 may include a database identifying available products and/or services (e.g., collectively referred to as items) which may be made available for viewing and purchase by the payer.

The merchant devices 704 also include a checkout application which may be configured to facilitate the purchase by the payer of items. The checkout application may be configured to accept payment information from the payer through the payer devices 702, the account providers through the account provider devices 708, from the payment service provider through the payment service provider device 706, and/or from the system provider through the system provider device 709 over the network 710.

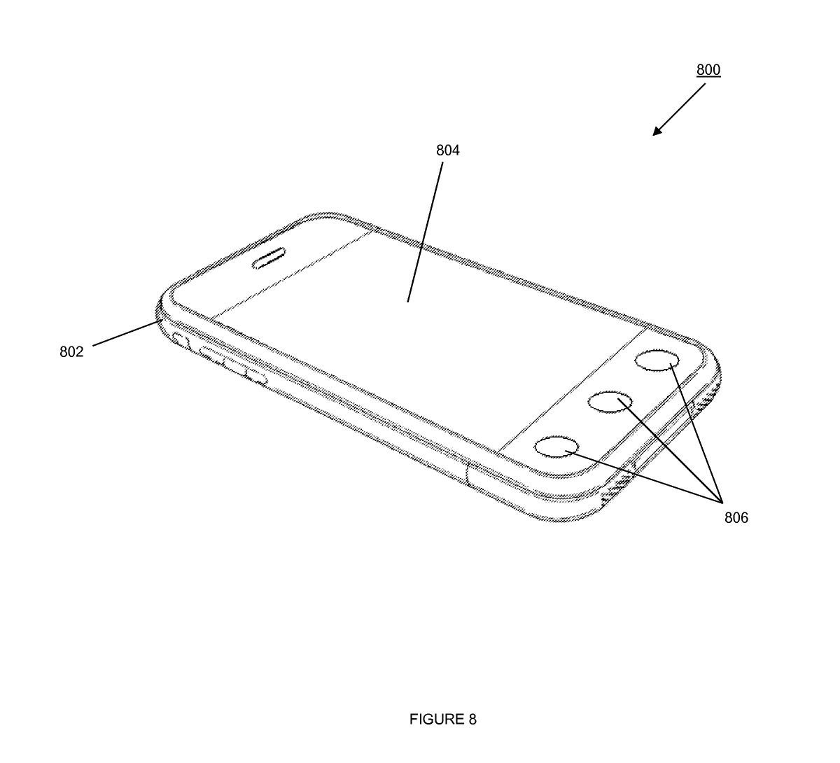

Referring now to FIG. 8, an embodiment of a payer device 800 is illustrated. The payer device 800 may be the payer devices 202a, 202b, 400, and/or 702. The payer device 800 includes a chassis 802 having a display 804 and an input device including the display 804 and a plurality of input buttons 806. One of skill in the art will recognize that the payer device 800 is a portable or mobile phone including a touch screen input device and a plurality of input buttons that allow the functionality discussed above with reference to the method 100. However, a variety of other portable/mobile payer devices and/or desktop payer devices may be used in the method 100 without departing from the scope of the present disclosure.

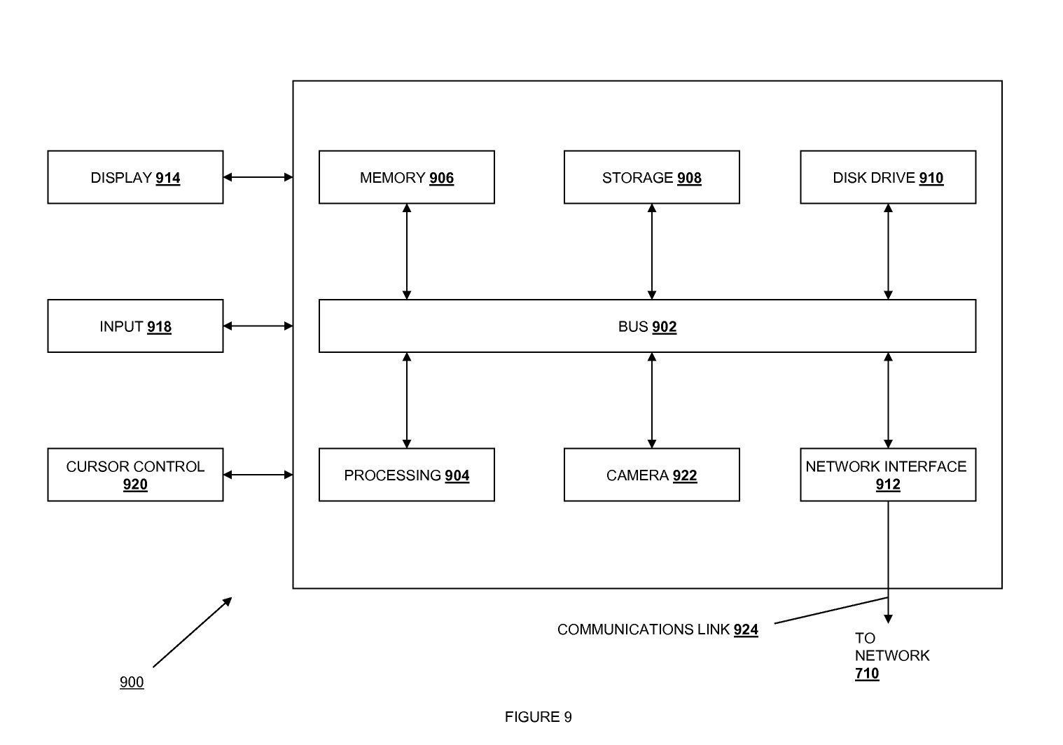

Referring now to FIG. 9, an embodiment of a computer system 800 suitable for implementing, for example, the payer devices 202a, 202b, 400, and/or 702, the merchant devices 204, 500, and/or 704, the payment service provider device 706, the account provider device 708, and/or the system provider devices 208, 302, and/or 709, is illustrated. It should be appreciated that other devices utilized by payer, merchants, payment service providers, account providers, and system providers in the purchase incentivizing system discussed above may be implemented as the computer system 900 in a manner as follows.

In accordance with various embodiments of the present disclosure, computer system 900, such as a computer and/or a network server, includes a bus 902 or other communication mechanism for communicating information, which interconnects subsystems and components, such as a processing component 904 (e.g., processor, micro-controller, digital signal processor (DSP), etc.), a system memory component 906 (e.g., RAM), a static storage component 908 (e.g., ROM), a disk drive component 910 (e.g., magnetic or optical), a network interface component 912 (e.g., modem or Ethernet card), a display component 914 (e.g., CRT or LCD), an input component 918 (e.g., keyboard, keypad, or virtual keyboard), a cursor control component 920 (e.g., mouse, pointer, or trackball), and/or a location determination component 922 (e.g., a Global Positioning System (GPS) device as illustrated, a cell tower triangulation device, and/or a variety of other location determination devices known in the art.) In one implementation, the disk drive component 910 may comprise a database having one or more disk drive components.

In accordance with embodiments of the present disclosure, the computer system 900 performs specific operations by the processor 904 executing one or more sequences of instructions contained in the memory component 906, such as described herein with respect to the payer devices 202a, 202b, 400, and/or 702, the merchant devices 204, 500, and/or 704, the payment service provider device 706, the account provider device 708, and/or the system provider devices 208, 302, and/or 709. Such instructions may be read into the system memory component 906 from another computer readable medium, such as the static storage component 908 or the disk drive component 910. In other embodiments, hard-wired circuitry may be used in place of or in combination with software instructions to implement the present disclosure.

Logic may be encoded in a computer readable medium, which may refer to any medium that participates in providing instructions to the processor 904 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 910, volatile media includes dynamic memory, such as the system memory component 906, and transmission media includes coaxial cables, copper wire, and fiber optics, including wires that comprise the bus 902. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 900. In various other embodiments of the present disclosure, a plurality of the computer systems 900 coupled by a communication link 924 to the network 710 (e.g., such as a LAN, WLAN, PTSN, and/or various other wired or wireless networks, including telecommunications, mobile, and cellular phone networks) may perform instruction sequences to practice the present disclosure in coordination with one another.

The computer system 900 may transmit and receive messages, data, information and instructions, including one or more programs (i.e., application code) through the communication link 924 and the network interface component 912. The network interface component 912 may include an antenna, either separate or integrated, to enable transmission and reception via the communication link 924. Received program code may be executed by processor 904 as received and/or stored in disk drive component 910 or some other non-volatile storage component for execution.

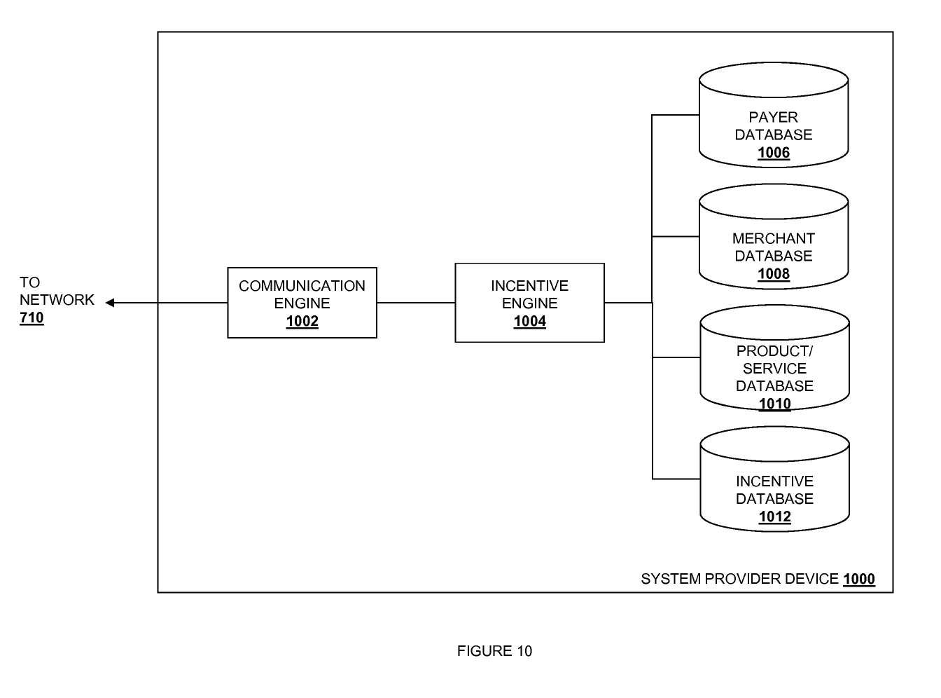

Referring now to FIG. 10, an embodiment of a purchase incentivizing system provider device 1000 is illustrated. In an embodiment, the device 1000 may be the payment service provider device 706, the account provider device 708, and/or the system provider devices 208, 302, and/or 709. The device 1000 includes a communication engine 1002 that is coupled to the network 710 and to an incentive engine 1004 that is coupled to a payer database 1006, a merchant database 1008, a product/service database 1010, and an incentive database 1012. The communication engine 1002 may be software or instructions stored on a computer-readable medium that allows the device 1000 to send and receive information over the network 710. The incentive engine 1004 may be software or instructions stored on a computer-readable medium that is operable to receive purchase information, associate purchase information in any of the databases 1006, 1008,1010, and 1012, determine that subsets of purchases qualify for incentives in the incentive database 1212, send incentives, receive incentive details, determine incentive details, determine that subsets of purchases are close to qualifying for incentives, send messages about payer incentives, determine spending behavior of payers, and/or perform any of the other functionality discussed above. While the databases 1006, 1008, 1010, and 1012 have been illustrated as located in the device 1000, one of skill in the art will recognize that they may be combined in any manner and connected to the incentive engine 1004 through the network 710 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and payers; however, a payer or consumer can pay, or otherwise interact with any type of recipient, including charities and individuals. The purchase does not have to involve a purchase, but may be a loan, a charitable contribution, a gift, etc. Thus, merchant as used herein can also include charities, individuals, and any other entity or person receiving a payment from a payer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A purchase incentivizing system, comprising:
a non-transitory memory storing payer information associated with a plurality of payers and merchant information associated with a plurality of merchants;
one or more hardware processors coupled to the memory and operable to read instructions from the memory to perform the steps of:
receiving, over a network, purchase information about a plurality of purchases made from the plurality of merchants by the plurality of payers, and associating the purchase information in a database with at least some of the payer information and the merchant information;
determining that a first subset of the plurality of purchases associated with a first merchant and a first payer in the database qualifies for a first incentive that is associated with the merchant information for the first merchant;
determining that a second subset of the plurality of purchases associated with a second merchant and a second payer in the database qualifies for a second incentive that is associated with the merchant information for the second merchant; and
sending the first incentive over the network to a first payer device associated with the first payer, and sending the second incentive over the network to a second payer device associated with the second payer.

2. The system of claim 1, wherein the one or more hardware processors are operable to read instructions from the memory to perform the steps of:
receiving the first incentive over the network from a first merchant device associated with the first merchant and storing the first incentive in the merchant information associated with the first merchant in the non-transitory memory; and
receiving the second incentive over the network from a second merchant device associated with the second merchant and storing the second incentive in the merchant information associated with the second merchant in the non-transitory memory.

3. The system of claim 1, wherein the one or more processors are operable to read instructions from the memory to perform the steps of:
determining the first incentive free of input from the first merchant and storing the first incentive in the merchant information associated with the first merchant in the non-transitory memory; and
determining the second incentive free of input from the second merchant and storing the second incentive in the merchant information associated with the second merchant in the non-transitory memory.

4. The system of claim 1, wherein the one or more processors are operable to read instructions from the memory to perform the steps of:
determining that a third subset of the plurality of purchases associated with a third merchant and a third payer in the database is within a number of purchases or a purchase amount of qualifying for a third incentive that is associated with the merchant information for the third merchant; and
sending a message over the network to a third payer device associated with the third payer including information about the number of purchases or the purchase amount for qualifying for the third incentive.

5. The system of claim 4, wherein the one or more processors are operable to read instructions from the memory to perform the steps of:
sending a message over the network to a third merchant device associated with the third merchant including information about the third user and the number of purchases or the purchase amount for qualifying for the third incentive; and
receiving an instruction from the third merchant device over the network to send a message over the network to a third payer device associated with the third payer including information about the number of purchases or the purchase amount for qualifying for the third incentive.

6. The system of claim 1, wherein the one or more processors are operable to read instructions from the memory to perform the steps of:
determining that a third subset of the plurality of purchases associated with a third merchant and a third payer in the database includes a third subset amount that is less than a fourth subset amount of a fourth subset of the plurality of purchases associated with the third merchant and the third payer in the database, where each purchase of the fourth subset of the plurality of purchases is associated with a time period that is prior to each purchase of the third subset of the plurality of purchases;
sending a message over the network to a third merchant device associated with the third merchant including information about the third user and the third subset amount being less than the fourth subset amount; and
receiving an instruction from the third merchant device over the network to send a third incentive over the network to a third payer device associated with the third payer.

7. A method for providing purchase incentives, comprising:
receiving, by a system provider device over a network, purchase information about a plurality of purchases made from a plurality of merchants by a plurality of payers, and associating the purchase information for each of the plurality of purchases in a database with payers that made that purchase and merchants from which that purchase was made;
determining, by the system provider device, that a first subset of the plurality of purchases associated with a first merchant and a first payer in the database qualifies for a first incentive that is associated with the first merchant in the database;
determining, by the system provider device, that a second subset of the plurality of purchases associated with a second merchant and a second payer in the database qualifies for a second incentive that is associated with the second merchant in the database;
sending, by the system provider device, the first incentive over the network to a first payer device associated with the first payer, and the second incentive over the network to a second payer device associated with the second payer.

8. The method of claim 7, further comprising:
receiving, by the system provider device, the first incentive over the network from a first merchant device associated with the first merchant and associating the first incentive with the first merchant in database; and
receiving, by the system provider device, the second incentive over the network from a second merchant device associated with the second merchant and associating the second incentive with the second merchant in the database.

9. The method of claim 7, further comprising:
determining the first incentive free of input from the first merchant and associating, by the system provider device, the first incentive with the first merchant in the database; and
determining the second incentive free of input from the second merchant and associating, by the system provider device, the second incentive with the second merchant in the database.

10. The method of claim 7, further comprising:
determining, by the system provider device, that a third subset of the plurality of purchases associated with a third merchant and a third payer in the database is within a number of purchases or a purchase amount of qualifying for a third incentive that is associated with the merchant information for the third merchant; and
sending, by the system provider device, a message over the network to a third payer device associated with the third payer including information about the number of purchases or the purchase amount for qualifying for the third incentive.

11. The method of claim 10, further comprising:
sending, by the system provider device, a message over the network to a third merchant device associated with the third merchant including information about the third user and the number of purchases or the purchase amount for qualifying for the third incentive; and
receiving, by the system provider device, an instruction from the third merchant device over the network to send a message over the network to a third payer device associated with the third payer including information about the number of purchases or the purchase amount for qualifying for the third incentive.

12. The method of claim 7, further comprising:
determining, by the a system provider device, that a third subset of the plurality of purchases associated with a third merchant and a third payer in the database includes a third subset amount that is less than a fourth subset amount of a fourth subset of the plurality of purchases associated with the third merchant and the third payer in the database, wherein each purchase of the fourth subset of the plurality of purchases is associated with a time period that is prior to each purchase of the third subset of the plurality of purchases;
sending, by the system provider device, a message over the network to a third merchant device associated with the third merchant including information about the third user and the third subset amount being less than the fourth subset amount; and
receiving, by the system provider device, an instruction from the third merchant device over the network to send a third incentive over the network to a third payer device associated with the third payer.

13. The method of claim 7, wherein the determining that the first subset of the plurality of purchases qualifies for the first incentive includes determining, by the system provider device, that the first subset includes a number of purchases or a purchases amount that exceeds a predetermined level included in incentive program details associated with the first merchant; and
wherein the determining that the second subset of the plurality of purchases qualifies for the second incentive includes determining, by the system provider device, that the second subset includes a number of purchases or a purchases amount that exceeds a predetermined level included in incentive program details associated with the second merchant.

14. A non-transitory machine-readable medium comprising a plurality of machine-readable instructions which, when executed by one or more processors, are adapted to cause the one or more processors to perform a method comprising:
receiving, over a network, purchase information for a plurality of purchases made from a plurality of merchants by a plurality of payers, and associating the purchase information for each of the plurality of purchases in a database with payers that made that purchase and merchants from which that purchase was made;
determining that a first subset of the plurality of purchases associated with a first merchant and a first payer in the database qualifies for a first incentive that is associated with the first merchant in the database;
determining that a second subset of the plurality of purchases associated with a second merchant and a second payer in the database qualifies for a second incentive that is associated with the second merchant in the database;
sending the first incentive over the network to a first payer device associated with the first payer, and the second incentive over the network to a second payer device associated with the second payer.

15. The non-transitory machine-readable medium of claim 14, wherein the method further comprises:
receiving the first incentive over the network from a first merchant device associated with the first merchant and associating the first incentive with the first merchant in database; and
receiving the second incentive over the network from a second merchant device associated with the second merchant and associating the second incentive with the second merchant in the database.

16. The non-transitory machine-readable medium of claim 14, wherein the method further comprises:
determining the first incentive free of input from the first merchant and associating the first incentive with the first merchant in the database; and
determining the second incentive free of input from the second merchant and associating the second incentive with the second merchant in the database.

17. The non-transitory machine-readable medium of claim 14, wherein the method further comprises:
determining that a third subset of the plurality of purchases associated with a third merchant and a third payer in the database is within a number of purchases or a purchase amount of qualifying for a third incentive that is associated with the merchant information for the third merchant; and
sending a message over the network to a third payer device associated with the third payer including information about the number of purchases or the purchase amount for qualifying for the third incentive.

18. The non-transitory machine-readable medium of claim 17, wherein the method further comprises:
sending a message over the network to a third merchant device associated with the third merchant including information about the third user and the number of purchases or the purchase amount for qualifying for the third incentive; and
receiving an instruction from the third merchant device over the network to send a message over the network to a third payer device associated with the third payer including information about the number of purchases or the purchase amount for qualifying for the third incentive.

19. The non-transitory machine-readable medium of claim 14, wherein the method further comprises:
determining that a third subset of the plurality of purchases associated with a third merchant and a third payer in the database includes a third subset amount that is less than a fourth subset amount of a fourth subset of the plurality of purchases associated with the third merchant and the third payer in the database, wherein each purchase of the fourth subset of the plurality of purchases is associated with a time period that is prior to each purchase of the third subset of the plurality of purchases;
sending a message over the network to a third merchant device associated with the third merchant including information about the third user and the third subset amount being less than the fourth subset amount; and
receiving, by a system provider device, an instruction from the third merchant device over the network to send a third incentive over the network to a third payer device associated with the third payer.

20. The non-transitory machine-readable medium of claim 14, wherein the determining that the first subset of the plurality of purchases qualifies for the first incentive includes determining that the first subset includes a number of purchases or a purchases amount that exceeds a predetermined level included in incentive program details associated with the first merchant; and
wherein the determining that the second subset of the plurality of purchases qualifies for the second incentive includes determining that the second subset includes a number of purchases or a purchases amount that exceeds a predetermined level included in incentive program details associated with the second merchant.
